(19) United States
(12) Patent Application Publication
(10) Pub. No.: US 2024/0153709 A1
(43) Pub. Date: May 9, 2024

(54) CERAMIC ELECTRONIC COMPONENT

(71) Applicant: Murata Manufacturing Co., Ltd., Kyoto (JP)

(72) Inventors: Hirofumi OIE, Kyoto (JP); Kiyohiro KASHIUCHI, Kyoto (JP); Toru YASO, Kyoto (JP)

(21) Appl. No.: 18/413,380

(22) Filed: Jan. 16, 2024

Related U.S. Application Data
(63) Continuation of application No. PCT/JP2022/027528, filed on Jul. 13, 2022.

(30) Foreign Application Priority Data
Jul. 19, 2021 (JP) 2021-118872

(51) Int. Cl. H01G 4/232; H01G 4/30

(52) U.S. Cl. CPC H01G 4/2325; H01G 4/30; H01G 4/12

(57) ABSTRACT

A ceramic electronic component of the present disclosure includes a first surface, a second surface opposite to the first surface, and a side surface interconnecting the first surface and the second surface, wherein a first base electrode is on the first surface, a side electrode connected to the first base electrode is on the side surface, and a ceramic protective layer covers at least a portion of an outline of at least one external electrode selected from the group consisting of the first base electrode and the side electrode.

### CROSS REFERENCE TO RELATED APPLICATION

This is a continuation of International Application No. PCT/JP2022/027528 filed on Jul. 13, 2022 which claims priority from Japanese Patent Application No. 2021-118872 filed on Jul. 19, 2021. The contents of these applications are incorporated herein by reference in their entireties.

### BACKGROUND OF THE DISCLOSURE

### Field of the Disclosure

The present disclosure relates to a ceramic electronic component.

### Description of the Related Art

One known example of multilayer ceramic electronic components to be mounted on a mounting substrate is a multilayer ceramic substrate having a structure in which an external terminal electrode is provided along a main surface of a component body including a stack of multiple ceramic layers.

For example, Patent Literature 1 discloses a multilayer ceramic electronic component to be mounted on a mounting substrate, including: a component body including a stack of multiple ceramic layers; an inner conductor inside the component body; an external terminal electrode obtained by baking a conductive paste on a first main surface of the component body and electrically connected to the mounting substrate, the first main surface extending in a direction in which the ceramic layers extend; an exposed portion exposed at the first main surface; and an embedded portion extending in an embedded manner inside the component body in at least a portion of a periphery of the exposed portion, wherein a ceramic composition in a covering ceramic layer (insulating cover layer) covering the embedded portion and exposed at the first main surface is different from a ceramic composition in a base ceramic layer defining the component body excluding the covering ceramic layer.
Patent Literature 1: JP 2012-164784 A

### BRIEF SUMMARY OF THE DISCLOSURE

The external terminal electrode of the multilayer ceramic electronic component disclosed in Patent Literature 1 is easily separated from the first main surface or cracked when stress is concentrated on the outline of the external terminal electrode.

The multilayer ceramic electronic component disclosed in Patent Literature 1 may include an additional external terminal electrode on another main surface opposite to the first main surface. The multilayer ceramic electronic component may include a side electrode on its side surface in order to interconnect the external terminal electrodes on the first main surface and the main surface opposite to the first main surface.

When stress is concentrated on the outline of the side electrode, the side electrode is easily separated from the side surface of the multilayer ceramic electronic component or cracked.

In other words, in the multilayer ceramic electronic component disclosed in Patent Literature 1, the external terminal electrodes and the side electrode defining external electrodes on the surfaces of the multilayer ceramic electronic component are insufficient in strength.

The present disclosure was made to solve the above issues. The present disclosure aims to provide a ceramic electronic component capable of preventing separation of an external electrode from a surface of the ceramic electronic component and cracking of the external electrode, even when stress is concentrated on the external electrode of the ceramic electronic component.

The ceramic electronic component of the present disclosure includes a first surface; a second surface opposite to the first surface; and a side surface interconnecting the first surface and the second surface, wherein a first base electrode is on the first surface; a side electrode connected to the first base electrode is on the side surface, the first base electrode and the side electrode serve as an external electrode, and a ceramic protective layer covers at least a portion of an outline of the external electrode.

The ceramic electronic component of the present disclosure can prevent separation of an external electrode from a surface of the ceramic electronic component and prevent cracking of the external electrode, even when stress is concentrated on the external electrode of the ceramic electronic component.

### BRIEF DESCRIPTION OF THE SEVERAL VIEWS OF THE DRAWINGS

FIG. 1 is a schematic perspective view of an example of a ceramic electronic component according to a first embodiment of the present disclosure.

FIG. 2 is a schematic view of an example of the ceramic electronic component according to the first embodiment of the present disclosure viewed from a direction perpendicular to a first surface.

FIG. 3 is a schematic view of an example of the ceramic electronic component according to the first embodiment of the present disclosure viewed from a direction perpendicular to a side surface.

FIG. 4 is a schematic view of an example of the ceramic electronic component according to the first embodiment of the present disclosure viewed from a direction perpendicular to a second surface.

FIG. 5 is an enlarged view of a portion surrounded by a broken line in FIG. 2.

FIG. 6A is a schematic plan view of an example shape of a first end of a side electrode on a corresponding first base electrode of the ceramic electronic component according to the first embodiment of the present disclosure.

FIG. 6B is a schematic plan view of another example shape of the first end of each side electrode on the corresponding first base electrode of the ceramic electronic component according to the first embodiment of the present disclosure.

FIG. 6C is a schematic plan view of an example case where the ceramic electronic component includes no protective layer on each first base electrode and the first end of each side electrode protrudes from the outline of the corresponding first base electrode.

FIG. 7A is a cross-sectional view taken along line A-A in FIG. 2.

FIG. 7B is a modified example of FIG. 7A.

FIG. 8A is a schematic view of another example of the ceramic electronic component according to the first embodiment of the present disclosure viewed from a direction perpendicular to the first surface.

FIG. 8B is a cross-sectional view taken along line B-B in FIG. 8A.

FIG. 8C is a schematic view of another example of the ceramic electronic component according to the first embodiment of the present disclosure viewed from a direction perpendicular to the side surface.

FIG. 9A is a schematic view of an example layout of the ceramic protective layers when the ceramic electronic component according to the first embodiment of the present disclosure is viewed from a direction perpendicular to the first surface.

FIG. 9B is a schematic view of an example layout of the ceramic protective layers when the ceramic electronic component according to the first embodiment of the present disclosure is viewed from a direction perpendicular to the first surface.

FIG. 9C is a schematic view of an example layout of the ceramic protective layers when the ceramic electronic component according to the first embodiment of the present disclosure is viewed from a direction perpendicular to the first surface.

FIG. 9D is a schematic view of an example layout of the ceramic protective layers when the ceramic electronic component according to the first embodiment of the present disclosure is viewed from a direction perpendicular to the first surface.

FIG. 9E is a schematic view of an example layout of the ceramic protective layers when the ceramic electronic component according to the first embodiment of the present disclosure is viewed from a direction perpendicular to the first surface.

FIG. 9F is a schematic view of an example layout of the ceramic protective layers when the ceramic electronic component according to the first embodiment of the present disclosure is viewed from a direction perpendicular to the first surface.

FIG. 10A is a schematic cross-sectional view of an example of a base element forming step during production of the ceramic electronic component according to the first embodiment of the present disclosure.

FIG. 10B is a schematic cross-sectional view of an example of a ceramic protective layer forming step during production of the ceramic electronic component according to the first embodiment of the present disclosure.

FIG. 10C is a schematic cross-sectional view of an example of a laminating step during production of the ceramic electronic component according to the first embodiment of the present disclosure.

FIG. 10D is a schematic cross-sectional view of an example of a pressing step during production of the ceramic electronic component according to the first embodiment of the present disclosure.

FIG. 10E is a schematic cross-sectional view of an example of a cutting step during production of the ceramic electronic component according to the first embodiment of the present disclosure.

FIG. 10F is a schematic cross-sectional view of an example of a side electrode forming step during production of the ceramic electronic component according to the first embodiment of the present disclosure.

FIG. 10G is a schematic cross-sectional view of an example of a firing step during production of the ceramic electronic component according to the first embodiment of the present disclosure.

FIG. 11 is a schematic cross-sectional view of an example of a ceramic electronic component according to a second embodiment of the present disclosure.

FIG. 12 is a schematic view of an example of a ceramic electronic component according to a third embodiment of the present disclosure viewed from a direction perpendicular to a side surface.

FIG. 13 is a schematic view of another example of the ceramic electronic component according to the third embodiment of the present disclosure viewed from a direction perpendicular to the side surface.

### DETAILED DESCRIPTION OF THE DISCLOSURE

Hereinafter, the ceramic electronic component of the present disclosure is described.

The present disclosure is not limited to the following preferred embodiments, and may be suitably modified without departing from the gist of the present disclosure. Combinations of two or more preferred features described in the following preferred embodiments are also within the scope of the present disclosure.

The ceramic electronic component of the present disclosure includes a first surface; a second surface opposite to the first surface; and a side surface interconnecting the first surface and the second surface, wherein a first base electrode is on the first surface; a side electrode connected to the first base electrode is on the side surface, the first base electrode and the side electrode serve as an external electrode, and a ceramic protective layer covers at least a portion of an outline of the external electrode.

As long as the above features are satisfied, the ceramic electronic component of the present disclosure may include any features within the range in which the effect of the present disclosure is obtained.

The following embodiments are examples, and features of different embodiments can be partially exchanged or combined with each other. In the second embodiment and subsequent embodiments, a description of features common to the first embodiment is omitted, and only different points are described. In particular, similar effects by similar features are not mentioned in each embodiment.

In the following description, the ceramic electronic component of each embodiment is simply referred to as “the ceramic electronic component of the present disclosure” when no distinction is made between the embodiments.

### First Embodiment

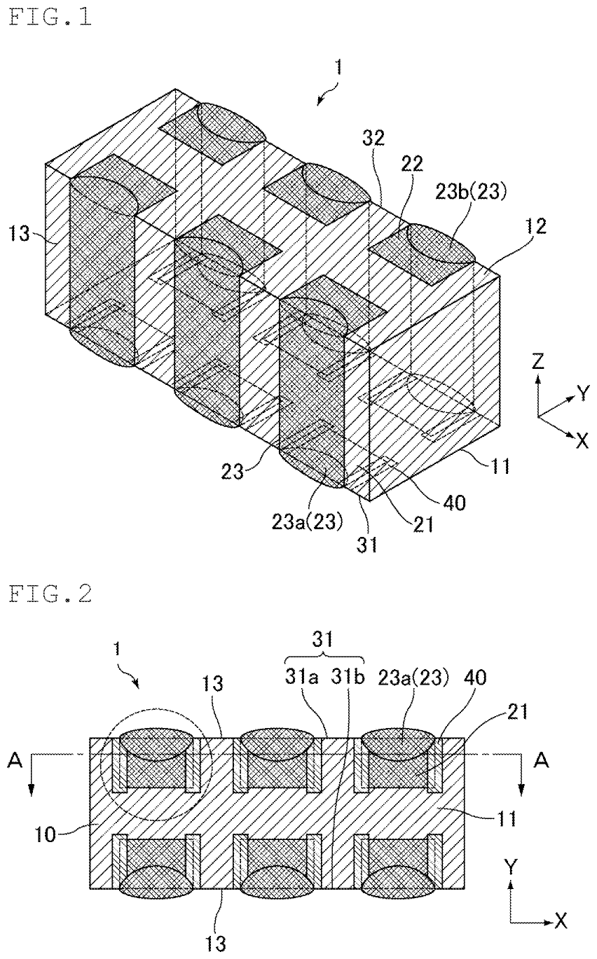

FIG. 1 is a schematic perspective view of an example of a ceramic electronic component according to a first embodiment of the present disclosure.

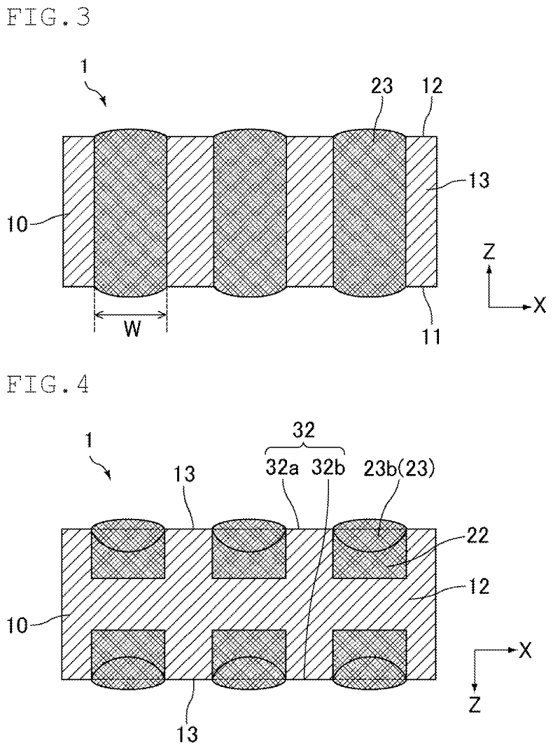

FIG. 2 is a schematic view of an example of the ceramic electronic component according to the first embodiment of the present disclosure viewed from a direction perpendicular to a first surface.

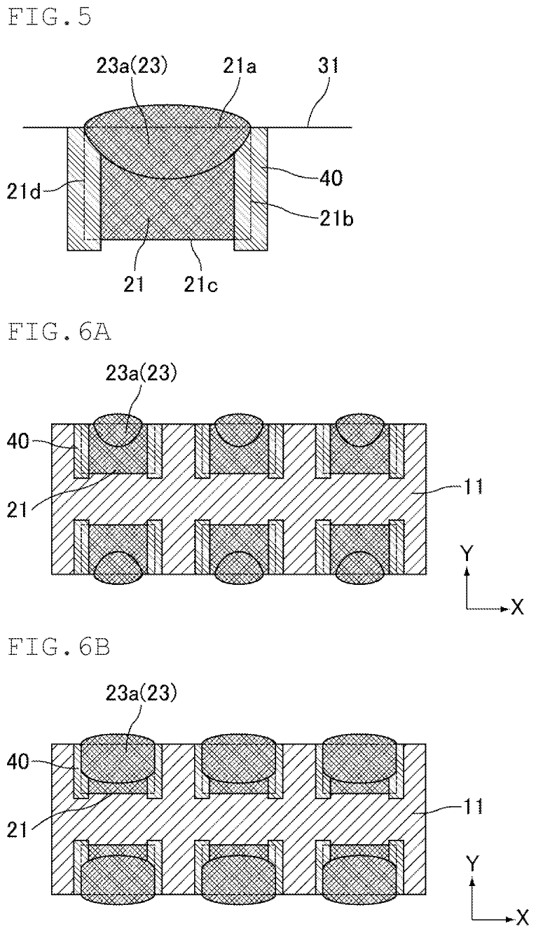

FIG. 3 is a schematic view of an example of the ceramic electronic component according to the first embodiment of the present disclosure viewed from a direction perpendicular to a side surface.

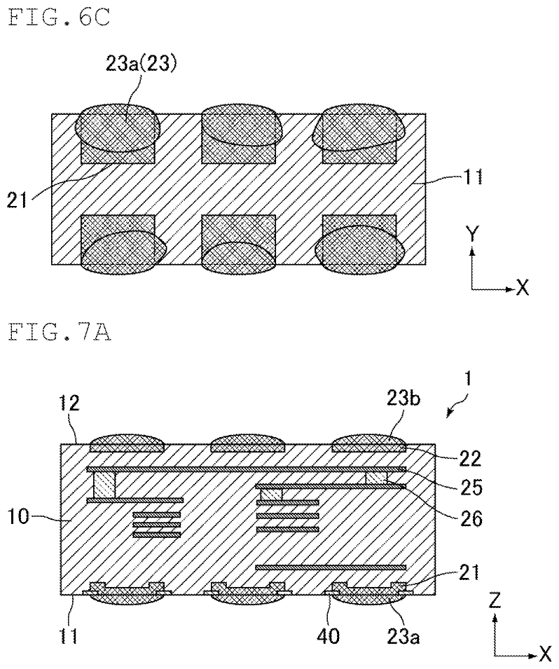

FIG. 4 is a schematic view of an example of the ceramic electronic component according to the first embodiment of the present disclosure viewed from a direction perpendicular to a second surface.

As shown in FIG. 1 to FIG. 4, a ceramic electronic component 1 includes a ceramic substrate 10 including a first surface 11, a second surface 12 opposite to the first surface 11, and a side surface 13 interconnecting the first surface 11 and the second surface 12.

The first surface 11 and the side surface 13 define a first ridgeline 31, and the second surface 12 and the side surface define a second ridgeline 32.

A first base electrode 21 is on the first surface 11. A second base electrode 22 is on the second surface 12. A side electrode 23 interconnecting the first base electrode 21 and the second base electrode 22 is on the side surface 13.

The first base electrode 21, the second base electrode 22, and the side electrode 23 define an external electrode of the ceramic electronic component 1. In the following description, the first base electrode 21, the second base electrode 22, and the side electrode 23 are collectively referred to as “the external electrode” when no distinction needs to be made.

As shown in FIG. 2, the first base electrode 21 has a rectangular shape in a plan view, and three first base electrodes 21 are formed along each of an upper first ridgeline 31a and a lower first ridgeline 31b.

As shown in FIG. 4, the second base electrode 22 has a rectangular shape in a plan view. Three second base electrodes 22 are formed along each of an upper second ridgeline 32a and a lower second ridgeline 32b.

The ceramic electronic component 1 includes six first base electrodes 21 on the first surface 11 and six second base electrodes 22 on the second surface 12. However, the ceramic electronic component of the present disclosure may have any number (one or more) of base elements.

For the sake of convenience, the description herein describes the first ridgeline on the upper side in FIG. 2 as “the upper first ridgeline 31a” and the first ridgeline on the lower side in FIG. 2 as “the lower first ridgeline 31b”. However, in the actual use of the ceramic electronic component 1, the first ridgeline 31a is not necessarily located on the upper side, and the first ridgeline 31b is not necessarily located on the lower side. The same applies to the second ridgelines shown in FIG. 4.

The ceramic electronic component of the present disclosure may include only one or more first base electrodes 21 on the first surface 11 and may include only one or more second base electrodes 22 on the second surface 12.

A first end 23a of each side electrode 23 extends onto the first base electrode 21 across the first ridgeline 31.

A second end 23b of each side electrode 23 extends onto the second base electrode 22 across the second ridgeline 32.

A ceramic protective layer 40 is on at least a portion of the outline of each first base electrode 21.

The ceramic protective layer 40, when formed, establishes a ceramic-to-ceramic bond between the ceramic substrate 10 and the ceramic protective layer 40, which is stronger than the bond between the ceramic substrate 10 and each first base electrode 21. Thus, separation of the first base electrode 21 from the surface of the ceramic electronic component 1 and cracking of the first base electrode 21 can be prevented, even when stress is concentrated on the first base electrode 21.

The ceramic electronic component 1 includes no ceramic protective layer on the outline of each second base electrode 22 and the outline of each side electrode 23.

Here, the shape of each first base electrode 21 is described in detail.

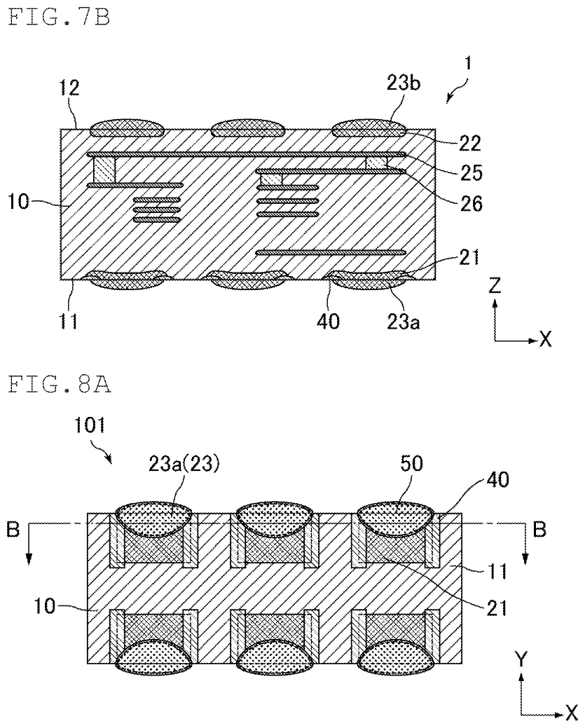

FIG. 5 is an enlarged view of a portion surrounded by a broken line in FIG. 2.

The first base electrode 21 shown in FIG. 5 has a rectangular shape in a plan view.

The outline of the first base electrode 21 is defined by a first line segment 21a, a second line segment 21b, a third line segment 21c, and a fourth line segment 21d. The first line segment 21a is parallel to the third line segment 21c, and the second line segment 21b is parallel to the fourth line segment 21d. The first line segment 21a interconnects the second line segment 21b and the fourth line segment 21d, and the third line segment 21c interconnects the second line segment 21b and the fourth line segment 21d.

The first line segment 21a coincides with the first ridgeline 31.

The ceramic protective layer 40 covers the second line segment 21b and the fourth line segment 21d, and the third line segment 21c is exposed.

As described later, each side electrode 23 may be formed by the dipping method. In this case, blur may be generated in the side electrode 23, and the side electrode 23 may protrude from the outline of the first base electrode 21 and may be formed on the first surface 11 other than the first base electrode 21.

However, the ceramic protective layer 40, when formed, can block the blur of the side electrode 23 and prevent formation of the side electrode 23 on the first surface 11 other than the first base electrode 21.

As described above, the first end 23a of each side electrode 23 extends onto the first base electrode 21 across the first ridgeline 31.

Here, a description is given on the shape of the first end 23a of the side electrode 23 on each first base electrode 21.

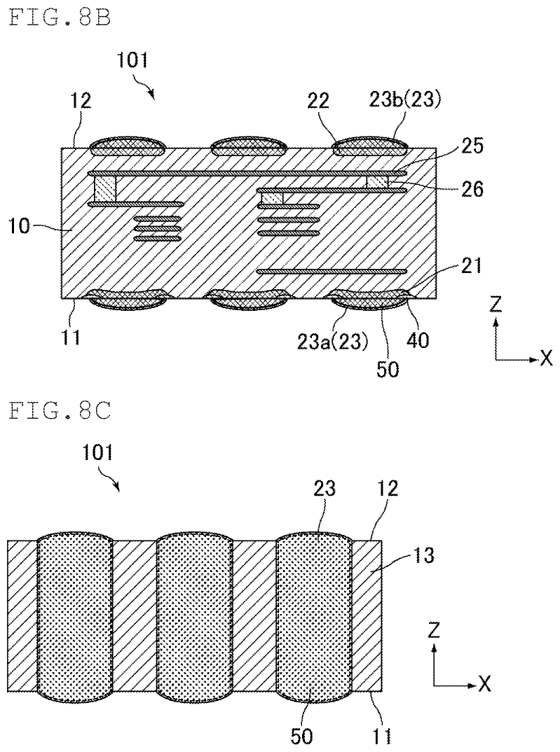

FIG. 6A is a schematic plan view of an example shape of a first end of a side electrode on a corresponding first base electrode of the ceramic electronic component according to the first embodiment of the present disclosure.

FIG. 6B is a schematic plan view of another example shape of the first end of each side electrode on the corresponding first base electrode of the ceramic electronic component according to the first embodiment of the present disclosure.

In the ceramic electronic component according to the first embodiment of the present disclosure, as shown in FIG. 6A, the first end 23a of each side electrode 23 on the first surface 11 may be inside the outline of the corresponding first base electrode 21.

In the ceramic electronic component according to the first embodiment of the present disclosure, as shown in FIG. 6B, the ceramic protective layer 40 covers a portion of the outline of each first base electrode 21. The first end 23a of each side electrode 23 may cover both the first base electrode 21 and the ceramic protective layer 40.

In any form, the first end 23a of each side electrode 23 can be in contact with the corresponding first base electrode 21, so that the side electrode 23 can interconnect the first base electrode 21 and the second base electrode 22.

Preferably, the first end 23a of each side electrode 23 is inside the outline of the corresponding first base electrode 21. The reason is explained below with reference to the drawings.

FIG. 6C is a schematic plan view of an example case where the ceramic electronic component includes no protective layer on each first base electrode and the first end of each side electrode protrudes from the outline of the corresponding first base electrode.

As shown in FIG. 6C, when no protective layer is on each first base electrode 21 and the first end 23a of each side electrode 23 protrudes from the outline of the corresponding first base electrode 21, the end 23a of each side electrode 23 extends onto the first surface 11, beyond the region where the first base electrode 21 is formed.

Thus, parasitic capacitance is generated between the internal electrode and the end 23a of each side electrode 23 which extends beyond the region of the first base electrode 21.

As shown in FIG. 6C, in each first base electrode 21, the end 23a of the side electrode 23 which extends beyond the region of the first base electrode 21 easily varies in size, causing variation in characteristics.

However, as shown in FIG. 6A and FIG. 6B, when the first end 23a of the side electrode 23 is inside the outline of the first base electrode 21, the variation in electrode area on each of the first surface 11 and the second surface 12 is reduced, so that the variation in characteristics is less likely to occur.

The width (the width indicated with a reference sign W in FIG. 3) of the end 23a of each side electrode 23 can be adjusted by the following method, for example. When the side electrodes 23 are formed by the dipping method, the width of the end 23a of each side electrode 23 to be formed can be adjusted by adjusting the dip width. The width of the end 23a of each side electrode 23 may be adjusted by masking the first base electrode 21 or the like.

When the side electrodes 23 are formed by screen printing, the width of the end 23a of each side electrode 23 can be adjusted by adjusting the opening width of a metal mask.

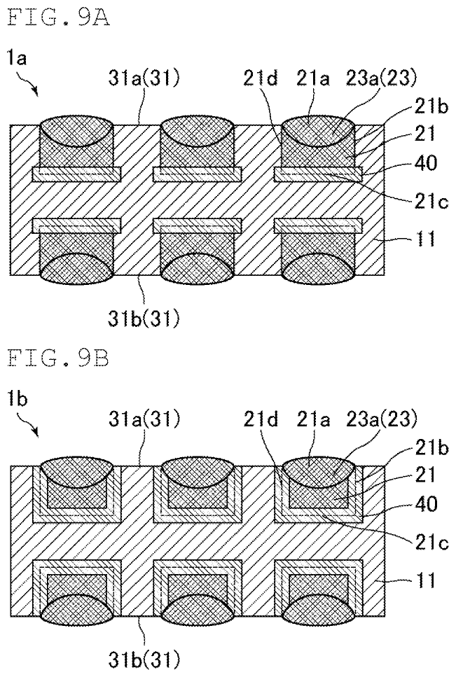

FIG. 7A is a cross-sectional view taken along line A-A in FIG. 2.

As shown in FIG. 7A, in the ceramic electronic component 1, the first base electrodes 21 and the ceramic protective layers 40 are embedded in the ceramic substrate 10. The surface of each first base electrode 21 and the surface of each ceramic protective layer 40 are flush with the first surface 11. In the ceramic electronic component of the present disclosure, the surface of each first base electrode and the surface of each ceramic protective layer may not be flush with the first surface, and the first base electrodes and the ceramic protective layers may protrude from the ceramic substrate, forming protrusions or may be pushed into the ceramic substrate, forming recesses.

When each first base electrode 21 and each ceramic protective layer 40 are embedded in the ceramic substrate 10 as described above, each first base electrode 21 is less susceptible to stress from a side of the first base electrode 21, so that separation of the first base electrode 21 from the surface of the ceramic electronic component 1 and cracking of the first base electrode 21 can be prevented.

The ceramic electronic component 1 includes internal electrodes 25, vias 26, and the like inside the ceramic substrate 10.

The internal electrodes 25, the vias 26, and the like are not limited, and those of the usual form with which the ceramic electronic component 1 can function are preferred.

In the ceramic electronic component 1, preferably, the first surface 11 is a mounting surface.

When the first surface 11 is a mounting surface, stress is easily concentrated on the first base electrode 21. However, in the ceramic electronic component 1, each ceramic protective layer 40 covers the second line segment 21b and the fourth line segment 21d of the corresponding first base electrode 21, which improves the mechanical strength (deflection strength, drop strength, adhesion strength, etc.) at the time of mounting. Thus, separation of the first base electrode 21 from the first surface 11 (the mounting surface) and cracking of the first base electrode 21 can be prevented, even when stress is concentrated on the first base electrode 21.

As shown in FIG. 7A, in the ceramic electronic component 1, the second base electrodes 22 are embedded in the ceramic substrate 10, and the surface of each second base electrode 22 is flush with the second surface. In the ceramic electronic component of the present disclosure, the second base electrodes may protrude from the ceramic substrate, forming protrusions, or may be pushed into the ceramic substrate, forming recesses.

FIG. 7B is a modified example of FIG. 7A.

Due to pressing conditions during production of the ceramic electronic component 1 or due to blur of printing during formation of the first base electrodes 21, the second base electrodes 22, the ceramic protective layer 40, and the like, there are cases where the end of each member is deformed or rounded as shown in FIG. 7B.

The ceramic electronic component 1 in such form is also the ceramic electronic component according to the first embodiment of the present disclosure.

Next, preferred materials and the like of each element of the ceramic electronic component are described.

### (Ceramic Substrate)

The ceramic substrate 10 may be a sintered body of a laminate of ceramic green sheets. The ceramic green sheets can be molded, for example, by doctor blading a ceramic slurry on a carrier film.

The ceramic slurry may contain, for example, a ceramic powder, a binder, and a plasticizer. The ceramic material may be, for example, a low temperature co-fired ceramic (LTCC) material. The low temperature co-fired ceramic material is a ceramic material that can be sintered at a temperature of 1000° C. or lower and that can be co-fired with low-resistive materials such as Au, Ag, Cu, and the like. Specific examples of the low temperature co-fired ceramic material include glass composite-based low temperature co-fired ceramic materials obtained by mixing a ceramic powder of alumina, zirconia, magnesia, forsterite, or the like with borosilicate glass; crystallized glass-based low temperature co-fired ceramic materials containing ZnO—MgO—Al₂O₃—SiO₂; and non-glass-based low temperature co-fired ceramic materials containing BaO—Al₂O₃—SiO₂-based ceramic powder, Al₂O₃—CaO—SiO₂—MgO—B₂O₃-based ceramic powder, or the like.

The thickness of each ceramic green sheet is preferably 5 μm or more and 100 μm or less, for example.

### (External Electrodes)

The external electrodes including the first base electrodes 21, the second base electrodes 22, and the side electrodes 23 may be formed by firing a conductive paste.

The conductive paste may contain any component. For example, it may contain a conductive metal material, a binder, a plasticizer, and the like. A co-base material (ceramic powder) for adjusting the shrinkage rate may be added to the conductive paste. Examples of conductive metal materials contained in the conductive paste include metals containing at least one of Ag, a Ag—Pt alloy, a Ag—Pd alloy, Cu, Ni, Pt, Pd, W, Mo, and Au as a main component. Among these conductive metal materials, Ag, a Ag—Pt alloy, a Ag—Pd alloy, and Cu are more preferably used particularly for conductive patterns for high frequency applications because these materials have low resistivity.

The conductive paste may or may not contain a glass component.

When the conductive paste contains a glass component, the sinterability between the external electrodes and the electronic component body can be improved.

In contrast, when the conductive paste does not contain a glass component, the metal in the conductive paste has a higher purity, so that the metal in the external electrodes to be formed also has a higher purity. This can reduce the resistance of the external electrodes.

An external electrode having desired electrical characteristics and structure can be obtained by adjusting the proportion of the glass component in the conductive paste.

### (Ceramic Protective Layer)

The ceramic protective layer may be a fired product of a ceramic paste for ceramic protective layers, which is obtained by adding an appropriate amount of an alumina (Al₂O₃) powder to a ceramic powder for the ceramic slurry and mixing them together to obtain a mixed raw material powder, dispersing the mixed raw material powder in an organic vehicle, and kneading.

The organic vehicle is a mixture of a binder and a solvent. The types of the binder and the solvent and the mixing ratio are not limited. Examples of the organic vehicle that can be used include solutions of acrylic resin, alkyd resin, butyral resin, ethyl cellulose, and the like in alcohols such as terpineol, isopropylene alcohol, butyl carbitol, and butyl carbitol acetate. If necessary, various types of dispersants, plasticizers, and activators may be added.

Next, another form of the ceramic electronic component according to the first embodiment of the present disclosure is described.

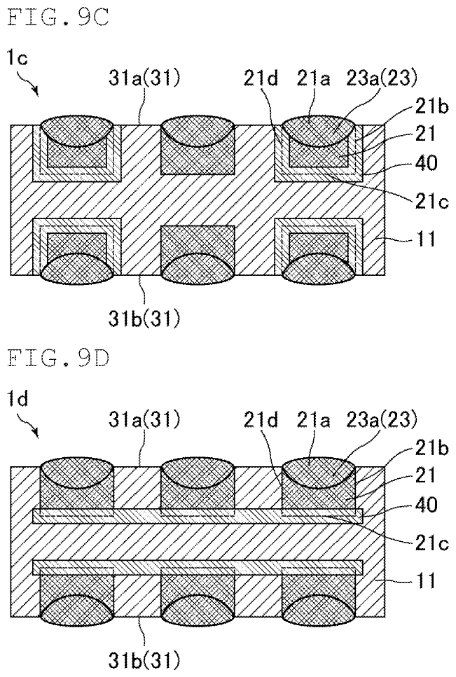

FIG. 8A is a schematic view of another example of the ceramic electronic component according to the first embodiment of the present disclosure viewed from a direction perpendicular to the first surface.

FIG. 8B is a cross-sectional view taken along line B-B in FIG. 8A.

FIG. 8C is a schematic view of another example of the ceramic electronic component according to the first embodiment of the present disclosure viewed from a direction perpendicular to the side surface.

A ceramic electronic component 101 shown in FIG. 8A, FIG. 8B, and FIG. 8C has the same features as the ceramic electronic component 1, except that a plating layer 50 is on a surface of each side electrode 23.

The plating layer 50 on the surface of the side electrode 23 functions as a barrier layer and can prevent solder leaching. Use of a material compatible with solder as a component of the plating layer 50 can improve the solder wettability.

Preferably, the plating layer 50 is formed by Sn/Ni plating or Au/Ni plating, although not limited thereto.

In the ceramic electronic component according to the first embodiment of the present disclosure, the layout of the ceramic protective layers is not limited as long as each ceramic protective layer covers at least a portion of the outline of each first base electrode.

For example, the ceramic electronic component according to the first embodiment of the present disclosure may include the first base electrodes and the ceramic protective layers at positions shown in the following drawings.

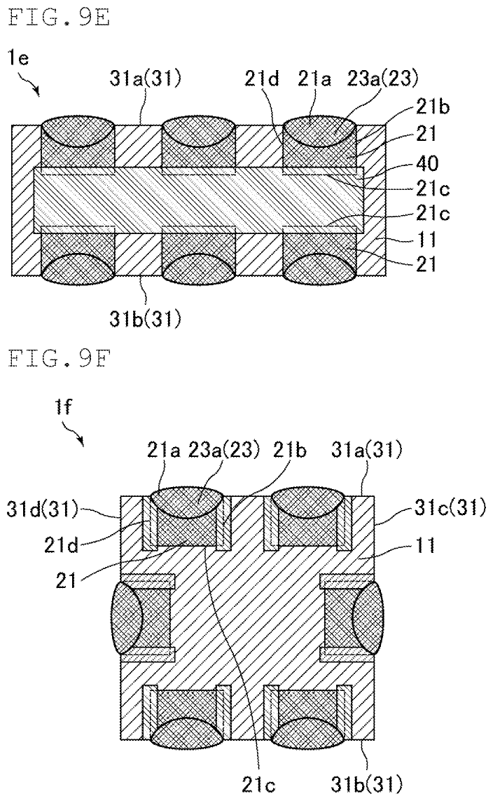

FIG. 9A to FIG. 9F are each a schematic view of an example layout of the ceramic protective layers when the ceramic electronic component according to the first embodiment of the present disclosure is viewed from a direction perpendicular to the first surface.

A ceramic electronic component 1a shown in FIG. 9A has the same features as the ceramic electronic component 1, except that the ceramic protective layer 40 covers the third line segment 21c and that the second line segment 21b and the fourth line segment 21d are exposed.

A ceramic electronic component 1b shown in FIG. 9B has the same features as the ceramic electronic component 1, except that the ceramic protective layer 40 covers the second line segments 21b, the third line segments 21c, and the fourth line segment 21d.

A ceramic electronic component 1c shown in FIG. 9C has the same features as the ceramic electronic component 1, except that the ceramic protective layer 40 covers the second line segment 21b, the third line segment 21c, and the fourth line segment 21d of the first base electrode 21 at each end among the first base electrodes 21 along the first ridgelines 31 (31a, 31b) and that the second line segment 21b, the third line segment 21c, and the fourth line segment 21d of each first base electrode 21 at a position other than the both ends are exposed.

A ceramic electronic component 1d shown in FIG. 9D has the same features as the ceramic electronic component 1a, except that the ceramic protective layer 40 continuously covers the third line segments 21c of the respective first base electrodes 21.

A ceramic electronic component 1e shown in FIG. 9E has the same features as the ceramic electronic component 1d, except that the ceramic protective layer 40 covering the third line segments 21c of the respective first base electrodes 21 along the upper first ridgeline 31a is connected to the ceramic protective layer 40 covering the third line segments 21c of the respective first base electrodes 21 along the lower first ridgeline 31b.

A ceramic electronic component if shown in FIG. 9F has the same features as the ceramic electronic component 1, except that it includes two first base electrodes 21 along the upper first ridgeline 31a, two first base electrodes 21 along the lower first ridgeline 31b as shown in FIG. 9F, one first base electrode 21 along a right first ridgeline 31c, and one first base electrode 21 along a left first ridgeline 31d as shown in FIG. 9F and that the ceramic protective layer 40 covers the second line segment 21b and the fourth line segment 21d of each first base electrode 21, and the third line segment 21c is exposed.

Preferably, the positions where the ceramic protective layers 40 are formed are suitably set according to an electronic component to be mounted on the ceramic electronic component 1.

Next, the method of producing the ceramic electronic component according to the first embodiment of the present disclosure is described.

The method of producing the ceramic electronic component according to the first embodiment of the present disclosure includes a base element forming step, a ceramic protective layer forming step, a laminating step, a pressing step, a cutting step, a side electrode forming step, and a firing step.

Each step is described below.

### (Base Element Forming Step)

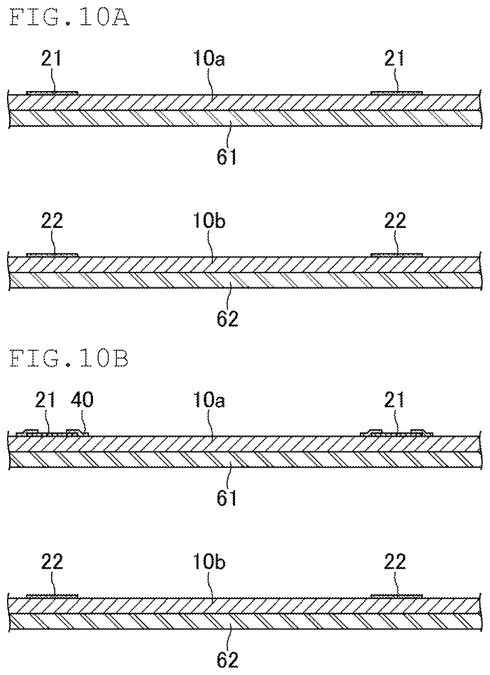

FIG. 10A is a schematic cross-sectional view of an example of a base element forming step during production of the ceramic electronic component according to the first embodiment of the present disclosure.

In this step, as shown in FIG. 10A, a ceramic green sheet 10a is stacked on a carrier film 61. Subsequently, the first base electrodes 21 in a raw state are formed on a surface of the ceramic green sheet 10a.

The surface of the ceramic green sheet 10a on which the first base electrodes 21 in a raw state are formed is a surface that becomes the first surface 11 of the ceramic substrate 10 after the subsequent steps.

A ceramic green sheet 10b is stacked on another carrier film 62. Subsequently, the second base electrodes 22 in a raw state are formed on a surface of the ceramic green sheet 10b. The surface of the ceramic green sheet 10b on which the second base electrode 22 in a raw state are formed is a surface that becomes the second surface 12 of the ceramic substrate 10 after the subsequent steps.

The first base electrodes 21 in a raw state and the second base electrodes 22 in a raw state can be formed by applying and drying a conductive paste.

### (Ceramic Protective Layer Forming Step)

FIG. 10B is a schematic cross-sectional view of an example of a ceramic protective layer forming step during production of the ceramic electronic component according to the first embodiment of the present disclosure.

In this step, as shown in FIG. 10B, the ceramic protective layer 40 in a raw state is formed to cover at least a portion of the outline of each first base electrode 21.

The ceramic protective layers 40 in a raw state can be formed by screen printing a ceramic paste onto a desired portion, using a metal mask with openings.

### (Laminating Step)

FIG. 10C is a schematic cross-sectional view of an example of a laminating step during production of the ceramic electronic component according to the first embodiment of the present disclosure.

In this step, as shown in FIG. 10C, a ceramic laminate 70 including the internal electrodes 25 and the vias 26 is prepared.

Subsequently, the ceramic green sheet 10a is separated from the carrier film 61 and stacked on the bottom of the ceramic laminate such that the first base electrodes 21 in a raw state face outside.

The ceramic green sheet 10b is separated from the carrier film 62 and stacked on the top of the ceramic laminate such that the second base electrodes 22 in a raw state face outside.

The ceramic laminate 70 can be produced by a conventionally known method.

### (Pressing Step)

FIG. 10D is a schematic cross-sectional view of an example of a pressing step during production of the ceramic electronic component according to the first embodiment of the present disclosure.

Subsequently, the ceramic green sheet 10a, the ceramic laminate 70, and the ceramic green sheet 10b are pressed. The pressing conditions are not limited, but pressing, for example, at 50 to 200 MPa is preferred. By the pressing step, as shown in FIG. 10D, the first base electrodes 21 in a raw state and the ceramic protective layers 40 in a raw state are embedded into the ceramic green sheet 10a, and the second base electrodes 22 in a raw state are embedded into the ceramic green sheet 10b.

### (Cutting Step)

FIG. 10E is a schematic cross-sectional view of an example of a cutting step during production of the ceramic electronic component according to the first embodiment of the present disclosure.

Next, as shown in FIG. 10E, the laminate including the ceramic green sheet 10a, the ceramic laminate 70, and the ceramic green sheet 10b is cut at positions each passing through the first base electrode 21 and the second base electrode 22, whereby a chip 2 is produced.

Subsequently, the chip 2 may be rounded by barrel finishing.

### (Side Electrode Forming Step)

FIG. 10F is a schematic cross-sectional view of an example of a side electrode forming step during production of the ceramic electronic component according to the first embodiment of the present disclosure.

Next, as shown in FIG. 10F, the side electrodes 23 in a raw state are formed on the respective side surfaces of the chip 2 by the dipping method. At this time, each side electrode 23 in a raw state is formed to interconnect the first base electrode 21 in a raw state and the second base electrode 22 in a raw state.

On each side surface of the chip 2, a ceramic water repellent film is formed at a portion where the side electrode 23 is not intended to be formed so as to prevent the formation of the side electrode 23.

The side electrodes 23 in a raw state may be formed by screen printing.

### (Firing Step)

FIG. 10G is a schematic cross-sectional view of an example of a firing step during production of the ceramic electronic component according to the first embodiment of the present disclosure.

Next, as shown in FIG. 10G, the chip 2 is fired into the ceramic electronic component 1. At this time, the ceramic green sheets and the ceramic laminate are fired into a ceramic substrate.

The firing conditions are not limited, but firing at 900° C. to 1000° C. is preferred.

The ceramic electronic component 1 can be produced by the above steps.

### Second Embodiment

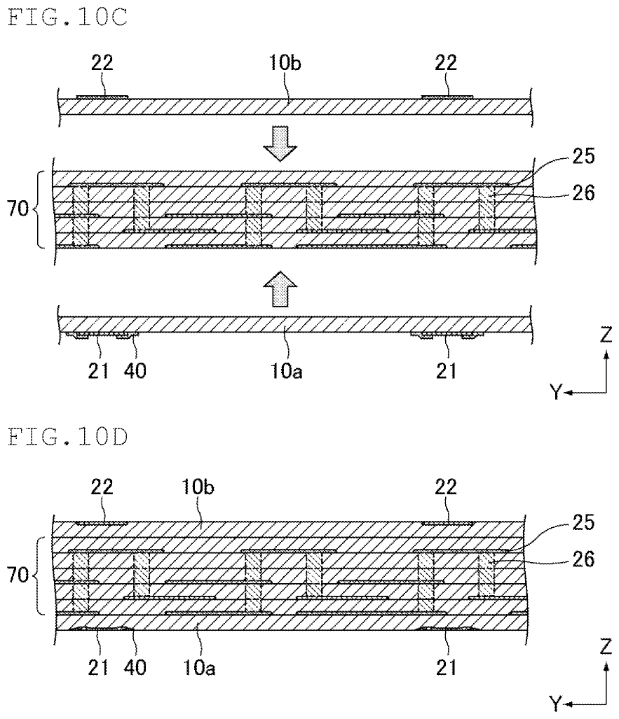

FIG. 11 is a schematic cross-sectional view of an example of a ceramic electronic component according to a second embodiment of the present disclosure.

A ceramic electronic component 201 shown in FIG. 11 has the same features as the ceramic electronic component 1 shown in FIG. 7B, except that the ceramic protective layer 40 covers a portion of the outline of each second base electrode 22.

The ceramic protective layer 40 covering a portion of the outline of each second base electrode 22 can prevent separation of the second base electrode 22 from the surface of the ceramic electronic component 201 and cracking of the second base electrode 22, even when stress is concentrated on the second base electrode 22.

The form of the protective layer on each second base electrode may be the same as that of the ceramic protective layer on each first base electrode of the ceramic electronic component according to the first embodiment.

### Third Embodiment

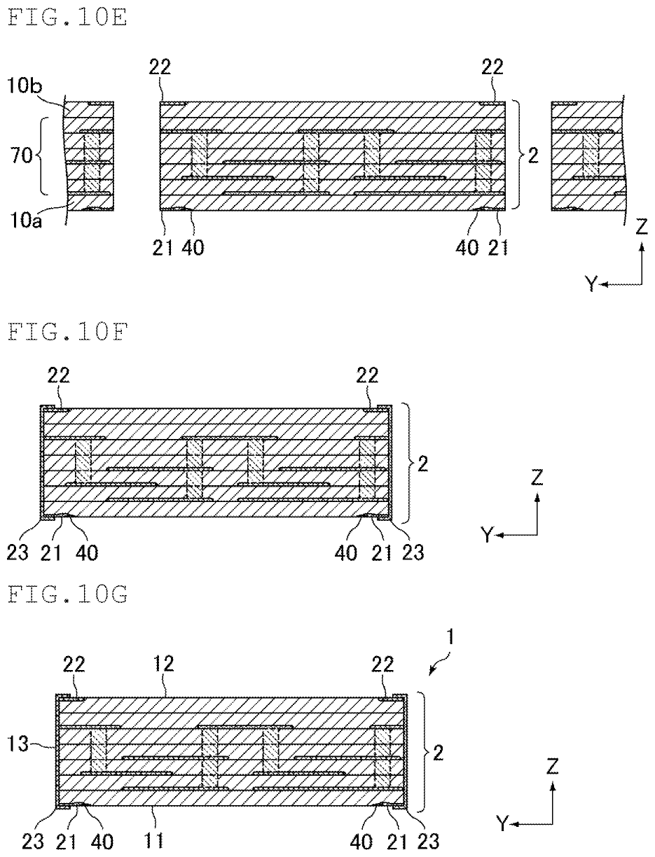

FIG. 12 is a schematic view of an example of a ceramic electronic component according to a third embodiment of the present disclosure viewed from a direction perpendicular to a side surface.

In a ceramic electronic component 301 shown in FIG. 12, the ceramic protective layer 40 covers the outline of each side 23s of each side electrode 23.

The ceramic electronic component 301 includes no ceramic protective layer on a portion of the outline of each first base electrode (not shown).

The ceramic electronic component 301 has the same features as the ceramic electronic component 1 shown in FIG. 1 to FIG. 4, except for the features described above.

The side electrodes 23 are easily separated because they are not formed by pressing. However, the ceramic protective layer 40 covering the outline of each side 23s of each side electrode 23 can prevent separation of the side electrode 23 from the surface of the ceramic electronic component 301 and cracking of the side electrode 23, even when stress is concentrated on the side electrode 23.

Next, another form of the ceramic electronic component according to the third embodiment of the present disclosure is described.

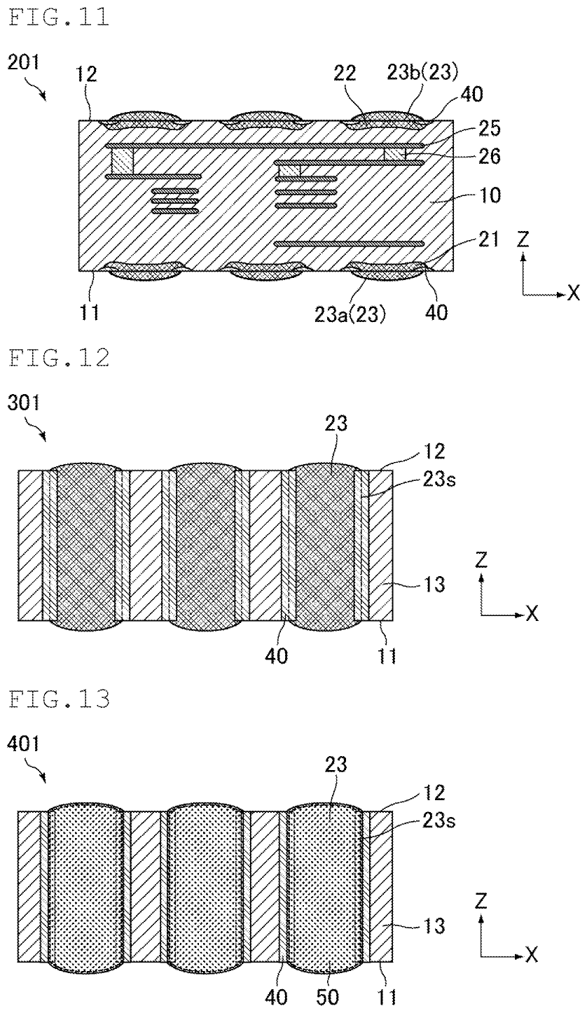

FIG. 13 is a schematic view of another example of the ceramic electronic component according to the third embodiment of the present disclosure viewed from a direction perpendicular to the side surface.

A ceramic electronic component 401 shown in FIG. 13 has the same features as the ceramic electronic component 301, except that the plating layer 50 is on the surface of each side electrode 23.

In the ceramic electronic component according to the third embodiment of the present disclosure, the ceramic protective layer 40 may cover a portion of the outline of each first base electrode 21. Preferably, but not necessarily, the ceramic protective layer 40 covers a portion of the outline of each second base electrode 22.

### Other Embodiments

In the ceramic electronic components according to the first to third embodiments which have been described thus far, the first base electrodes and the second base electrodes each have a rectangular shape in a plan view.

However, in the ceramic electronic component of the present disclosure, the first base electrodes and the second base electrodes may each have any shape in a plan view, such as a triangle, convex polygon, concave polygon, circle, semicircle, oval, or the like.

In the ceramic electronic components according to the first to third embodiments which have been described thus far, the first line segment of each first base electrode coincides with the first ridgeline. However, the ceramic electronic component of the present disclosure may have a gap between the first line segment of each first base electrode and the first ridgeline. In this case, the side electrode may be on a surface of the gap. In other words, each side electrode may be formed in an L-shape, extending over the side surface and the first main surface of the ceramic substrate.

The ceramic electronic components according to the first to third embodiments which have been described thus far include the second base electrodes. However, the ceramic electronic component of the present disclosure may not include any second base electrodes and may include only the first base electrodes and the side electrodes.

In the method of producing the ceramic electronic component according to the first embodiment, the side electrodes were formed by the dipping method. However, in the ceramic electronic component of the present disclosure, the side electrodes may be formed by the following method.

Specifically, in the laminating step, the ceramic green sheets and the ceramic laminate are stacked such that vias each interconnecting the first base electrode in a raw state and the second base electrode in a raw state are formed; and in the cutting step, vias each interconnecting the first base electrode and the second base electrode are formed inside the ceramic substrate, and the vias are vertically cut to obtain side electrodes (also referred to as “half-cut electrodes”).

In this case, there is no need to form the side electrodes by the dipping method.
1, 1a, 1b, 1c, 1d, 1e, 1f, 101, 201, 301, 401 ceramic electronic component
2 chip
10 ceramic substrate
10a, 10b ceramic green sheet
11 first surface
12 second surface
13 side surface
21 first base electrode
21a first line segment
21b second line segment
21c third line segment
21d fourth line segment
22 second base electrode
23 side electrode
23a first end of side electrode
23b second end of side electrode
25 internal electrode
26 via
31, 31a, 31b, 31c, 31d first ridgeline
32, 32a, 32b second ridgeline
40 ceramic protective layer
50 plating layer
61, 62 carrier film
70 ceramic laminate

1. A ceramic electronic component comprising:
a ceramic substrate including a first surface, a second surface opposite to the first surface, and a side surface interconnecting the first surface and the second surface;
a first base electrode being on the first surface;
a side electrode connected to the first base electrode and being on the side surface; and
a ceramic protective layer covering at least a portion of an outline of the external electrode, wherein
the first base electrode and the side electrode serve as an external electrode.

2. The ceramic electronic component according to claim 1, further comprising:
a second base electrode being on the second surface, wherein
the side electrode interconnects the first base electrode and the second base electrode, and
the first base electrode, the side electrode, and the second base electrode serve as the external electrode.

3. The ceramic electronic component according to claim 1,
wherein when the first surface is viewed from a direction perpendicular to the first surface, the ceramic protective layer covers a portion of an outline of the first base electrode.

4. The ceramic electronic component according to claim 1,
wherein when the side surface is viewed from a direction perpendicular to the side surface, the ceramic protective layer covers a portion of an outline of the side electrode.

5. The ceramic electronic component according to claim 1,
wherein the ceramic substrate includes a first ridgeline defined by the first surface and the side surface,
a first end of the side electrode is also on the first base electrode across the first ridgeline, and
the first end of the side electrode on the first surface is inside an outline of the first base electrode.

6. The ceramic electronic component according to claim 1,
wherein the ceramic substrate includes a first ridgeline defined by the first surface and the side surface,
when the first surface is viewed from a direction perpendicular to the first surface, the ceramic protective layer covers a portion of an outline of the first base electrode, and
a first end of the side electrode covers both the first base electrode and the ceramic protective layer across the first ridgeline.

7. The ceramic electronic component according to claim 1,
wherein the ceramic substrate includes a first ridgeline defined by the first surface and the side surface,
when the first surface is viewed from a direction perpendicular to the first surface, the first base electrode has a rectangular shape in a plan view, and an outline of the first base electrode is defined by a first line segment, a second line segment, a third line segment, and a fourth line segment,
the first line segment is parallel to the third line segment, the first line segment interconnects the second line segment and the fourth line segment, and the third line segment interconnects the second line segment and the fourth line segment, and
the first line segment overlaps with the first ridgeline.

8. The ceramic electronic component according to claim 7,
wherein the ceramic protective layer covers the second line segment and the fourth line segment, and the third line segment is exposed.

9. The ceramic electronic component according to claim 7,
wherein the ceramic protective layer covers the second line segment, the third line segment, and the fourth line segment.

10. The ceramic electronic component according to claim 7,
wherein the ceramic protective layer covers the third line segment, and the second line segment and the fourth line segment are exposed.

11. The ceramic electronic component according to claim 7,
wherein the first base electrode includes multiple first base electrodes along the first ridgeline, and
the ceramic protective layer covers the second line segment, the third line segment, and the fourth line segment of the first base electrode at least at each end among the multiple first base electrodes along the first ridgeline.

12. The ceramic electronic component according to claim 7,
wherein the first base electrode includes multiple first base electrodes along the first ridgeline, and
the ceramic protective layer continuously covers the third line segments of the respective multiple first base electrodes.

13. The ceramic electronic component according to claim 1,
wherein a surface of the first base electrode is flush with the first surface, and
the side electrode is connected to the surface of the first base electrode.

14. The ceramic electronic component according to claim 2,
wherein when the first surface is viewed from a direction perpendicular to the first surface, the ceramic protective layer covers a portion of an outline of the first base electrode.

15. The ceramic electronic component according to claim 2,
wherein when the side surface is viewed from a direction perpendicular to the side surface, the ceramic protective layer covers a portion of an outline of the side electrode.

16. The ceramic electronic component according to claim 3,
wherein when the side surface is viewed from a direction perpendicular to the side surface, the ceramic protective layer covers a portion of an outline of the side electrode.

17. The ceramic electronic component according to claim 2,
wherein the ceramic substrate includes a first ridgeline defined by the first surface and the side surface,
a first end of the side electrode is also on the first base electrode across the first ridgeline, and
the first end of the side electrode on the first surface is inside an outline of the first base electrode.

18. The ceramic electronic component according to claim 3,
wherein the ceramic substrate includes a first ridgeline defined by the first surface and the side surface,
a first end of the side electrode is also on the first base electrode across the first ridgeline, and
the first end of the side electrode on the first surface is inside an outline of the first base electrode.

19. The ceramic electronic component according to claim 4,
wherein the ceramic substrate includes a first ridgeline defined by the first surface and the side surface,
a first end of the side electrode is also on the first base electrode across the first ridgeline, and
the first end of the side electrode on the first surface is inside an outline of the first base electrode.

20. The ceramic electronic component according to claim 2,
wherein the ceramic substrate includes a first ridgeline defined by the first surface and the side surface,
when the first surface is viewed from a direction perpendicular to the first surface, the ceramic protective layer covers a portion of an outline of the first base electrode, and
a first end of the side electrode covers both the first base electrode and the ceramic protective layer across the first ridgeline.
